(19) United States
(12) Patent Application Publication
(10) Pub. No.: US 2025/0306504 A1
(43) Pub. Date: Oct. 2, 2025

(54) DEVELOPING APPARATUS

(71) Applicant: CANON KABUSHIKI KAISHA, Tokyo (JP)

(72) Inventors: Yukihide Ito, Kanagawa (JP); Tomofumi Kawamura, Shizuoka (JP); Ryota Ooka, Shizuoka (JP)

(21) Appl. No.: 19/089,519

(22) Filed: Mar. 25, 2025

(30) Foreign Application Priority Data
Mar. 29, 2024 (JP) 2024-057906

(51) Int. Cl. G03G 15/08

(52) U.S. Cl. CPC G03G 15/0891; G03G 15/0856

(57) ABSTRACT

A developing apparatus includes an accommodation portion for developer, a conveying member with a rotating shaft and sheet for conveying developer, and a sensing portion with first and second conducting members for sensing electrostatic capacitance based on developer amount. An accommodation portion frame body features a recessed portion with intersecting first and second inner wall faces bearing the conducting members. The recessed portion extends from an inner side of the accommodation portion toward an outer side. During image formation, the first inner wall faces downward while the second inner wall faces upward with an inclination angle exceeding the developer's angle of repose. The intersection line of imaginary lines passing through these wall faces lies below the rotation axis line.

### BACKGROUND OF THE INVENTION

### Field of the Invention

The present invention relates to a developing apparatus.

### Description of the Related Art

In a conventional electrophotographic image forming apparatus, which employs an electrophotographic image forming process, a developer container having a configuration in which toner is stirred in an accommodation portion for toner (developer) is adopted. A toner cartridge serving as an example of a developer container is provided therein with a developer accommodation chamber, in which toner for image formation is accommodated, and a developing chamber for developing images, and image formation is realized by conveying toner from the developer accommodation chamber to the developing chamber.

Now, a remaining amount sensing portion that senses the remaining amount of toner is provided within the toner cartridge, in order to notify users of decrease in a toner amount due to image formation. The remaining amount sensing portion calculates a total remaining amount in which the remaining toner amount in the developer accommodation chamber and in the developing chamber are totaled, by sensing the toner amount conveyed therethrough. In particular, there is demand for improvement in remaining amount sensing precision when the remaining toner amount is small, for the purpose of notifying users of decrease in the remaining toner amount.

A conveying member is provided in a toner accommodation portion, in order to secure cyclicity of toner within the toner cartridge. The conveying member is made up of a stirring member, which is an elastic member that has flexibility, and a shaft portion, and is rotatably supported within the toner cartridge. A method has been proposed for sensing the remaining toner amount in such a configuration, by performing conveying while scooping the toner up by the stirring member to the remaining amount sensing portion that is provided upward from a rotation shaft of the conveying member (Japanese Patent Application Publication No. 2023-107244).

However, in this configuration, the stirring member is in an orientation that is close to being horizontal when passing through the remaining amount sensing portion, and accordingly a phenomenon occurs in which part of the toner being conveyed when passing through the remaining amount sensing portion spills off the stirring member, from a distal end side of the stirring member toward a rotation shaft side of the conveying member. This occurs when the remaining toner amount is small in a state where even higher sensing precision is demanded. At this time, the amount of toner, which is pressed into the remaining amount sensing portion by the distal end of the stirring member and sensed, becomes unstable, and there is a possibility that the stability of remaining toner amount inside the toner cartridge that is ultimately calculated will also deteriorate.

### SUMMARY OF THE INVENTION

There is demand for further improvement in sensing precision in a case of performing remaining amount sensing of developer while stirring and conveying the developer inside of a developer container.

The present invention has been made in light of the foregoing problem, and an object thereof is to improve sensing precision of remaining developer amount in a developing apparatus.

The present invention provides a developing apparatus, comprising:
an accommodation portion configured to accommodate a developer;
a conveying member that is provided in the accommodation portion, and that has a shaft portion that is rotatably supported about a rotation axis line and a sheet that is flexible and is connected to the shaft portion, wherein the conveying member is configured to convey the developer with the sheet in conjunction with rotation of the shaft portion; and
a sensing portion that includes a first conducting member and a second conducting member provided in the accommodation portion, wherein the sensing portion is configured to sense electrostatic capacitance, in accordance with an amount of developer, between the first conducting member and the second conducting member, wherein
a frame body of the accommodation portion is provided with a recessed portion including (i), in a cross-section that is perpendicular to the rotation axis line, a first inner wall face which constitutes the accommodation portion and on which the first conducting member is provided, and (ii) a second inner wall face which extends in a direction intersecting the first inner wall face and also is adjacent to the first inner wall face and on which the second conducting member is provided, wherein the recessed portion is recessed from an inner side toward an outer side of the accommodation portion,
in a case where the developing apparatus is oriented for use in image formation in an image forming apparatus, the first inner wall face is oriented downward, and the second inner wall face is oriented upward and also has an inclination angle that is greater than or equal to an angle of repose of the developer, and
in the cross-section, an intersection where a first imaginary line that passes through the first inner wall face and a second imaginary line that passes through the second inner wall face intersect is downward from the rotation axis line.

According to the present invention, sensing precision of a remaining developer amount in a developing apparatus can be improved.

Further features of the present invention will become apparent from the following description of exemplary embodiments with reference to the attached drawings.

### BRIEF DESCRIPTION OF THE DRAWINGS

FIG. 1A is a cross-sectional view for describing a configuration for improving remaining amount sensing precision;

FIG. 1B is an enlarged cross-sectional view for describing the configuration for improving remaining amount sensing precision;

FIG. 1C is an enlarged cross-sectional view for describing the configuration for improving remaining amount sensing precision;

FIG. 2 is a cross-sectional schematic view of an image forming apparatus;

FIG. 3 is a cross-sectional view of a process cartridge;

FIG. 4 is a cross-sectional view of the image forming apparatus;

FIG. 5 is a cross-sectional view of the image forming apparatus;

FIG. 6 is a cross-sectional view of the image forming apparatus;

FIG. 7 is a disassembled perspective view of a drum unit;

FIG. 8 is a disassembled perspective view of a developing unit;

FIG. 9 is a perspective assembly diagram of the process cartridge;

FIG. 10 is a perspective view of the process cartridge;

FIG. 11 is a cross-sectional view of the developing unit, for describing placement of a remaining amount sensing portion;

FIGS. 12A and 12B are a frontal view and a side view of a developing frame body, for describing sensing results of the remaining amount sensing portion;

FIG. 13A is a cross-sectional view for describing the way in which toner is conveyed (remaining toner amount small);

FIG. 13B is a cross-sectional view for describing the way in which toner is conveyed (remaining toner amount small);

FIG. 13C is a cross-sectional view for describing the way in which toner is conveyed (remaining toner amount small);

FIG. 14A is a cross-sectional view for describing the way in which toner is conveyed (remaining toner amount great);

FIG. 14B is a cross-sectional view for describing the way in which toner is conveyed (remaining toner amount great);

FIG. 14C is a cross-sectional view for describing the way in which toner is conveyed (remaining toner amount great);

FIG. 15A is a cross-sectional view for describing the way in which toner is conveyed in another configuration (remaining toner amount great);

FIG. 15B is a cross-sectional view for describing the way in which toner is conveyed in another configuration (remaining toner amount great); and

FIG. 15C is a cross-sectional view for describing the way in which toner is conveyed in another configuration (remaining toner amount great).

### DESCRIPTION OF THE EMBODIMENTS

A suitable embodiment for carrying out the present invention will be exemplarily described below in detail with reference to the drawings and embodiments. Note that the functions, materials, shapes, and dimensions, relative placements thereof, and so forth, of the components described in the embodiment are to be changed as appropriate in accordance with a configuration of an apparatus to which the invention is to be applied, various types of conditions, and so forth, and are not intended to limit the scope of this invention these alone, unless specifically stated as such.

### First Embodiment

A first embodiment will be described below with reference to the drawings. In the first embodiment, an image forming apparatus to which four process cartridges are detachably attachable is exemplified as the image forming apparatus. Note that the number of process cartridges attached to the image forming apparatus is not limited to this. The number of process cartridges is to be set as appropriate, in accordance with need. Also, a laser beam printer is exemplified as a form of the image forming apparatus in the embodiment described below.

### Schematic Configuration of Image Forming Apparatus

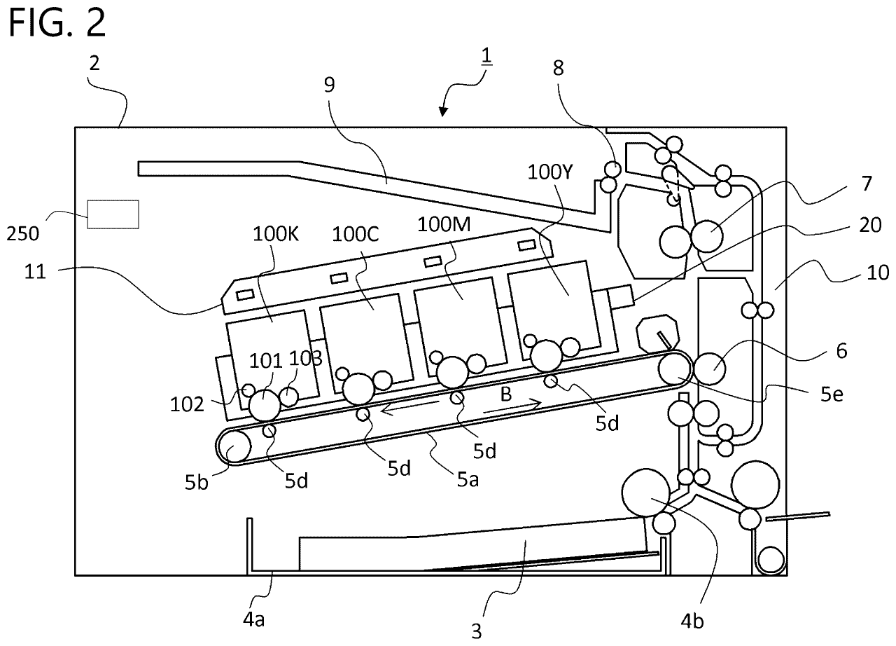

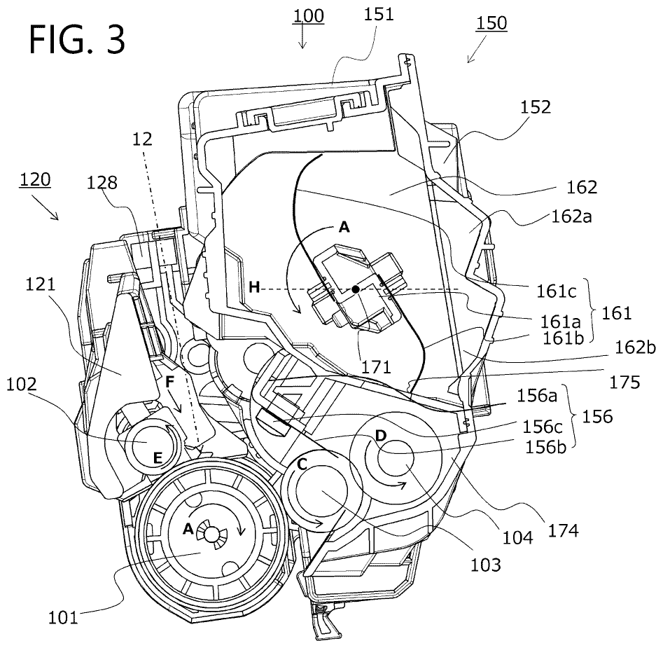

An overall configuration of an electrophotographic image forming apparatus 1 (hereinafter, referred to as “image forming apparatus 1”) according to the present embodiment will be described with reference to FIG. 2. FIG. 2 is a cross-sectional schematic view of the image forming apparatus 1. Also, FIG. 3 is a cross-sectional view of a process cartridge 100.

This image forming apparatus 1 is a four-color full-color laser beam printer that performs color image formation on a recording medium 3 using an electrophotographic process. The image forming apparatus 1 uses a process cartridge system, in which process cartridges 100 are detachably attached to an image forming apparatus main body 2, and color images are formed on the recording medium 3.

Now, with respect to the image forming apparatus 1, a side on which a front door 10 is provided will be referred to as “front face”, and a face on the opposite side from the front face as “rear face” (back face). Also, when viewing the image forming apparatus 1 from the front face, a right side will be referred to as “driving side”, a left side as “non-driving side”, an upper side as “upper face”, and a lower side as “lower face”. FIG. 2 is a cross-sectional view, viewing the image forming apparatus 1 from the non-driving side, in which a near side from the plane of the drawing is the non-driving side of the image forming apparatus 1, the right side in the plane of the drawing is the front face of the image forming apparatus 1, and a far side from the plane of the drawing is the driving side of the image forming apparatus 1.

The driving side of the process cartridges 100 is a side on which later-described drum coupling members (photosensitive member coupling members) are disposed as viewed from a photosensitive drum axis line direction, and is a side on which later-described developing coupling members are disposed as viewed from a developing roller 103 (developer bearing member) axis line direction.

First through fourth process cartridges 100 (100Y, 100M, 100C, 100K) are disposed in the image forming apparatus main body 2. The first to fourth process cartridges 100 (100Y, 100M, 100C, 100K) have electrophotographic process mechanisms that are the same as each other, with colors and filling amounts of developer (hereinafter referred to as “toner”) differing. Accordingly, when there is no need to distinguish thereamong in the following, these will be collectively described with the suffixes Y to K omitted. A direction of array of the first through fourth process cartridges 100 may be a substantially horizontal direction, for example.

Rotational driving force is transmitted from a drive output portion (details to be described later) of the image forming apparatus main body 2 to the first through fourth process cartridges 100, and bias voltage (charging bias, developing bias, residual electrostatic sensing bias, and so forth) is supplied from contact points of the image forming apparatus main body 2 to the process cartridges 100.

As can be seen from the cross-sectional view in a direction orthogonal to a rotation axis line in FIG. 3, the process cartridge 100 according to the present embodiment has a drum unit 120 that includes a photosensitive drum 101 and charging means serving as process means to act on this photosensitive drum 101. Note that there are cases in which the drum unit 120 has not only the charging means serving as the process means, but also cleaning means.

The process cartridges 100 also each have a developing unit 150 equipped with developing means for developing an electrostatic latent image on the photosensitive drum 101. The drum unit 120 and the developing unit 150 are linked to each other. A more detailed configuration of the process cartridges 100 will be described later.

The first process cartridge 100Y accommodates yellow (Y) toner in a developing frame body thereof, and forms yellow-color toner images on a surface of the photosensitive drum 101. The second process cartridge 100M accommodates magenta (M) toner in a developing frame body thereof, and forms magenta-color toner images on the surface of the photosensitive drum 101. The third process cartridge 100C accommodates cyan (C) toner in a developing frame body thereof, and forms cyan-color toner images on the surface of the photosensitive drum 101. The fourth process cartridge 100K accommodates black (K) toner in a developing frame body thereof, and forms black-color toner images on the surface of the photosensitive drum 101.

A laser scanner unit 11 is provided upward from the first to fourth process cartridges 100, as exposing means. This laser scanner unit 11 outputs laser light 12 in accordance with image information. The laser light 12 then passes through an exposing window 128 of the process cartridges 100, whereby scanning exposure of the surface of the photosensitive drum 101 is performed.

An intermediate transfer unit 5 serving as a transfer member is provided downward from the first through fourth process cartridges 100. This intermediate transfer unit 5 has a driving roller 5e and a tension roller 5b over which a transfer belt 5a, which is flexible, is run.

A lower face of the photosensitive drum 101 of each of the first through fourth process cartridges 100 comes into contact with an upper face of the transfer belt 5a. This portion of contact is a primary transfer portion. A primary transfer roller 5d is provided on an inner side of the transfer belt 5a at a position facing the photosensitive drum 101.

A secondary transfer roller 6 abuts the driving roller 5e across the transfer belt 5a. A portion of contact of the transfer belt 5a and the secondary transfer roller 6 is a secondary transfer portion.

A feeding unit 4 is provided downward from the intermediate transfer unit 5. This feeding unit 4 has a sheet feed tray 4a that accommodates the recording medium 3 stacked therein, and a sheet feed roller 4b.

A fixing apparatus 7 and a sheet discharging apparatus 8 are provided to the upper right within the image forming apparatus main body 2 in FIG. 2. An upper face of the image forming apparatus main body 2 makes up a sheet discharge tray 9. The toner image is fixed on the recording medium 3 by fixing means provided to the fixing apparatus 7, and the recording medium 3 is discharged to the sheet discharge tray 9.

### Image Forming Operations

Next, a process of image forming operations to form full-color images will be described. The photosensitive drums 101 of the first through fourth process cartridges 100 are rotationally driven at a predetermined speed (direction of arrow A in FIG. 3). The transfer belt 5a is also rotationally driven at a speed corresponding to the speed of the photosensitive drums 101 in a forward direction (direction of arrow B in FIG. 2) with respect to the rotation of the photosensitive drums 101.

The laser scanner unit 11 is also driven. Synchronously with the driving of the laser scanner unit 11, a charging roller 102 in each of the process cartridges 100 uniformly charges the surface of the photosensitive drum 101 to a predetermined polarity and potential. Scanning exposure of the surface of each photosensitive drum 101 by the laser light 12, in accordance with image signals of the respective colors, is performed by the laser scanner unit 11.

Accordingly, an electrostatic latent image in accordance with image signals of the corresponding color is formed on the surface of each photosensitive drum 101. The electrostatic latent image that is formed is developed by the developing roller 103 that is rotationally driven in a forward direction corresponding to the rotation of the photosensitive drum 101 (direction of arrow C in FIG. 3), at a predetermined speed.

Through the electrophotographic image forming process operations described above, a yellow-color toner image corresponding to a yellow component of the full-color image is formed on the photosensitive drum 101 of the first process cartridge 100Y. Primary transfer of this toner image onto the transfer belt 5a is then performed.

In the same way, a magenta-color toner image corresponding to a magenta component of the full-color image is formed on the photosensitive drum 101 of the second process cartridge 100M. Primary transfer of this toner image onto the yellow-color toner image already transferred onto the transfer belt 5a, is then performed in a superimposed manner.

In the same way, a cyan-color toner image corresponding to a cyan component of the full-color image is formed on the photosensitive drum 101 of the third process cartridge 100C. Primary transfer of this toner image onto the yellow-color and magenta-color toner images already transferred onto the transfer belt 5a, is then performed in a superimposed manner.

In the same way, a black-color toner image corresponding to a black component of the full-color image is formed on the photosensitive drum 101 of the fourth process cartridge 100K. Primary transfer of this toner image onto the yellow-color, magenta-color, and cyan-color toner images already transferred onto the transfer belt 5a, is then performed in a superimposed manner. Thus, a full-color unfixed toner image of the four colors of yellow color, magenta color, cyan color, and black color is formed on the transfer belt 5a.

Meanwhile, the recording medium 3 is separated and fed, one sheet at a time, at a predetermined control timing. The recording medium 3 is guided to the secondary transfer portion, which is an abutting portion of the secondary transfer roller 6 and the transfer belt 5a, at a predetermined control timing.

Thus, the four-color superimposed toner image on the transfer belt 5a is transferred collectively in sequence onto a face of the recording medium 3, in a process of the recording medium 3 being conveyed to the secondary transfer portion. The configuration of the image forming apparatus main body will be described below in further detail.

A control unit 250 that the image forming apparatus 1 has is made up of an information processing apparatus that is equipped with computing resources, such as processors, memory, and so forth. In the image forming apparatus 1, the components of the image forming apparatus 1 operate to perform image forming operations such as described above, on the basis of image information provided from an external apparatus or the like, or image information read by a scanner. The image forming operations are executed by the control unit 250 controlling the components of the image forming apparatus 1 in accordance with programs and instructions input by a user.

### Overview of Process Cartridge Attaching/Detaching Configuration

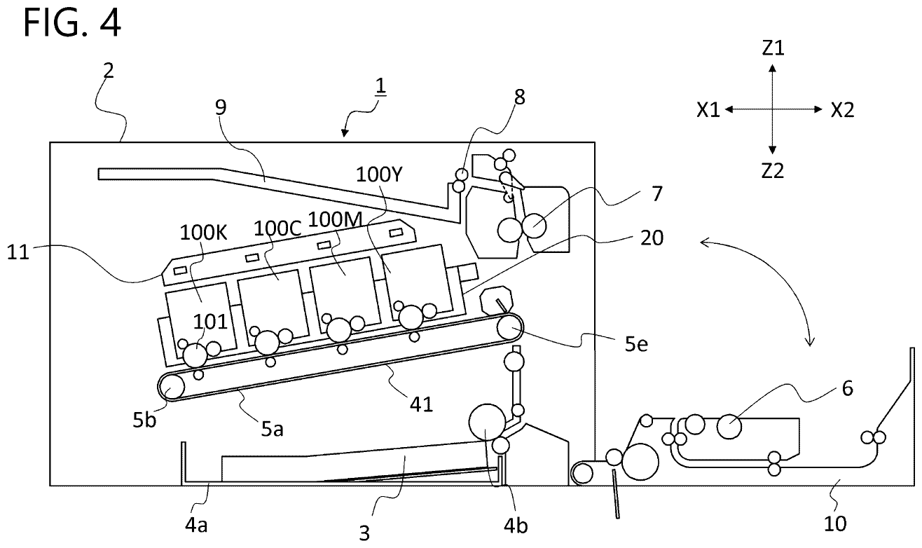

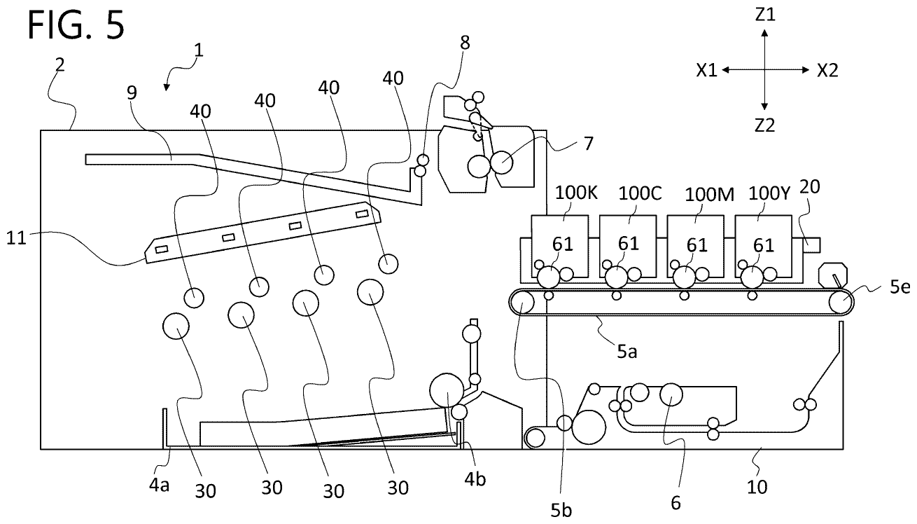

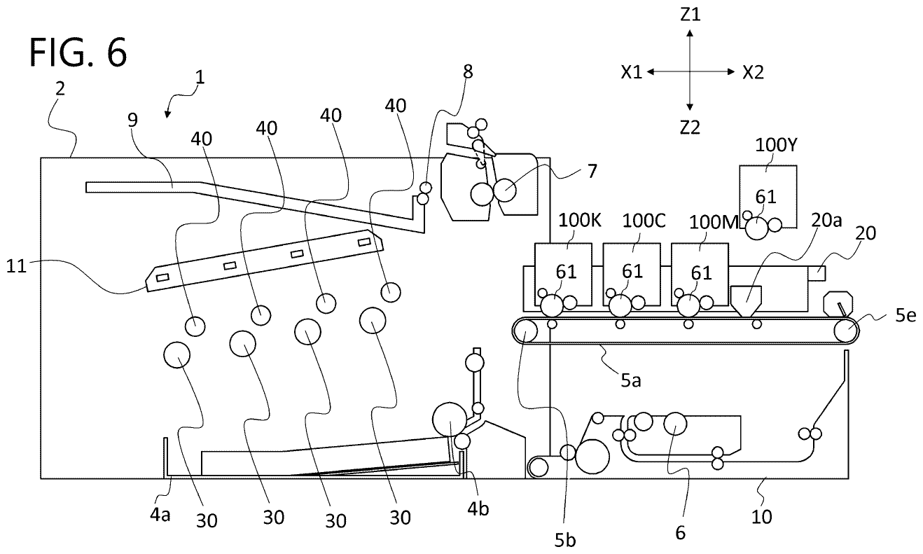

A cartridge tray 20 (hereinafter referred to as “tray 20”) that supports the process cartridges 100 will be described in further detail, with reference to FIGS. 4 to 6. FIG. 4 is a cross-sectional view of the image forming apparatus 1 in a state in which the tray 20 is situated on the inner side of the image forming apparatus main body 2, in a state in which the front door 10 is open. FIG. 5 is a cross-sectional view of the image forming apparatus 1 in a state in which the tray 20 is situated on the outer side of the image forming apparatus main body 2 in a state in which the front door 10 is open, and the process cartridges 100 are accommodated within the tray 20. FIG. 6 is a cross-sectional view of the image forming apparatus 1 in a state in which the tray 20 is situated on the outer side of the image forming apparatus main body 2 in a state in which the front door 10 is open, and one of the process cartridges 100 is removed from the tray 20.

As illustrated in FIGS. 4 and 5, the tray 20 is movable in an X1 direction (direction of pushing in) and an X2 direction (direction of drawing out) with respect to the image forming apparatus main body 2, which are substantially horizontal directions. That is to say, the tray 20 is provided so as to be capable of being drawn out and being pushed in with respect to the image forming apparatus main body 2, and the tray 20 is configured to be capable of moving in the substantially horizontal directions in a state in which the image forming apparatus main body 2 is installed on a level face. Note that a state in which the tray 20 is situated on the inner side of the image forming apparatus main body 2 in a state in which the front door 10 is open (state in FIG. 4) will be referred to as “inside position”. Also, a state in which the tray 20 is situated on the outer side of the image forming apparatus main body 2 (state in FIG. 5) will be referred to as “outside position”. In the inside state and the outside state, the photosensitive drum 101 and the transfer belt 5a are in a state of being distanced from each other.

The tray 20 also has an attaching portion 20a by which the first process cartridge 100Y is detachably attachable at the outside position, as illustrated in FIG. 6. (In the same way, the tray 20 also has attaching portions 20a by which the second to fourth process cartridges 100M, 100C, and 100K are detachably attachable.) The process cartridges 100 then move to the inner side of the image forming apparatus main body 2 along with the movement of the tray 20, in a state of the process cartridges 100 being disposed on the attaching portions 20a. In the present embodiment, closing the front door 10 causes the intermediate transfer unit 5 to move upward in an arrow Z1 direction, by a link mechanism that is omitted from illustration, to a position of forming images (position at which the photosensitive drums 101 and the transfer belt 5a are in contact). Also, opening the front door 10 causes the intermediate transfer unit 5 to descend in a Z2 direction, and the photosensitive drums 101 and the transfer belt 5a are distanced from each other.

As described above, a plurality of the process cartridges 100 can be moved by the tray 20 to the inner side of the image forming apparatus main body 2 together, to a positions where image formation can be performed, and can also be drawn out together to the outer side of the image forming apparatus main body 2.

### Overall Configuration of Process Cartridge

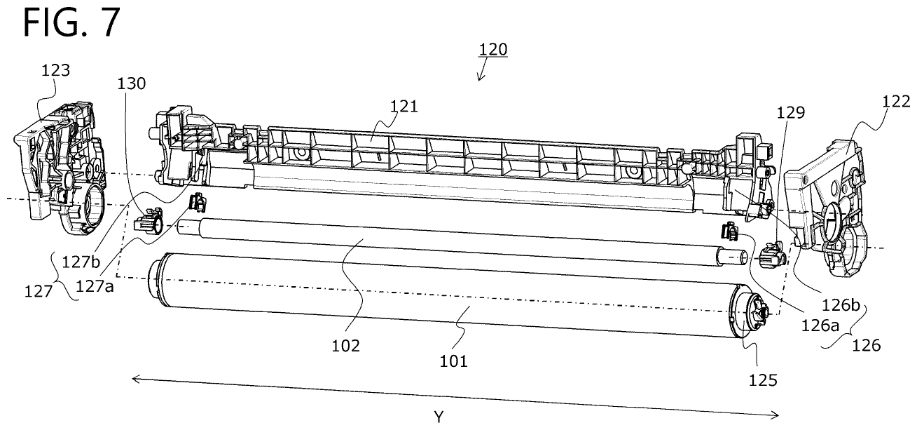

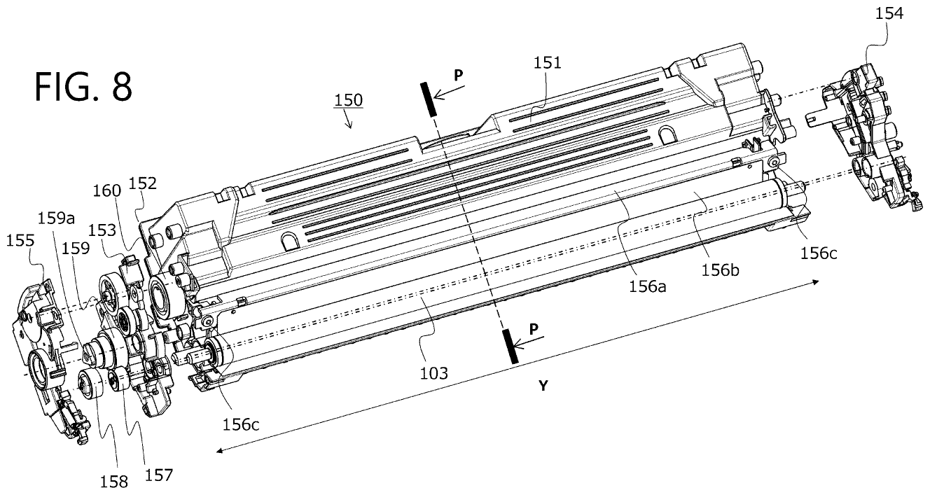

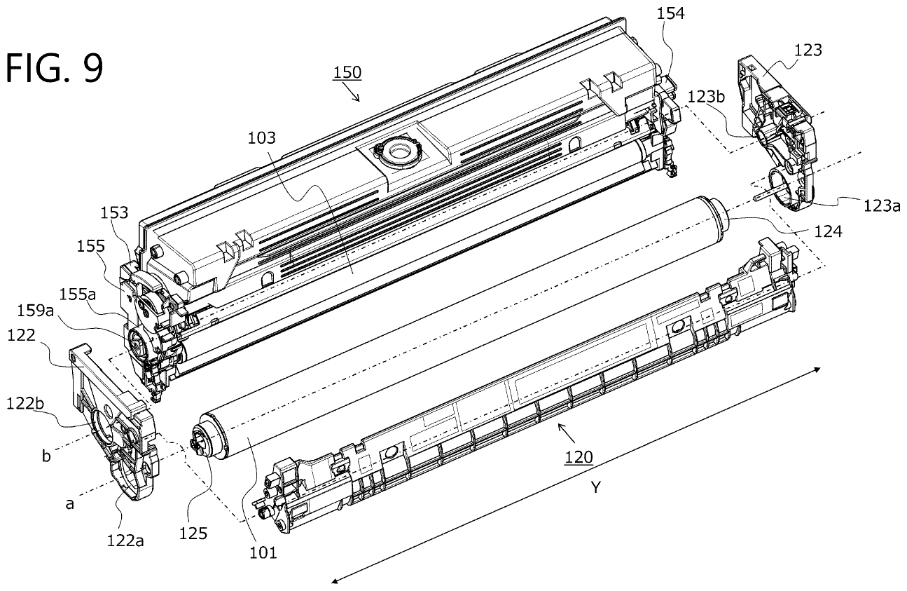

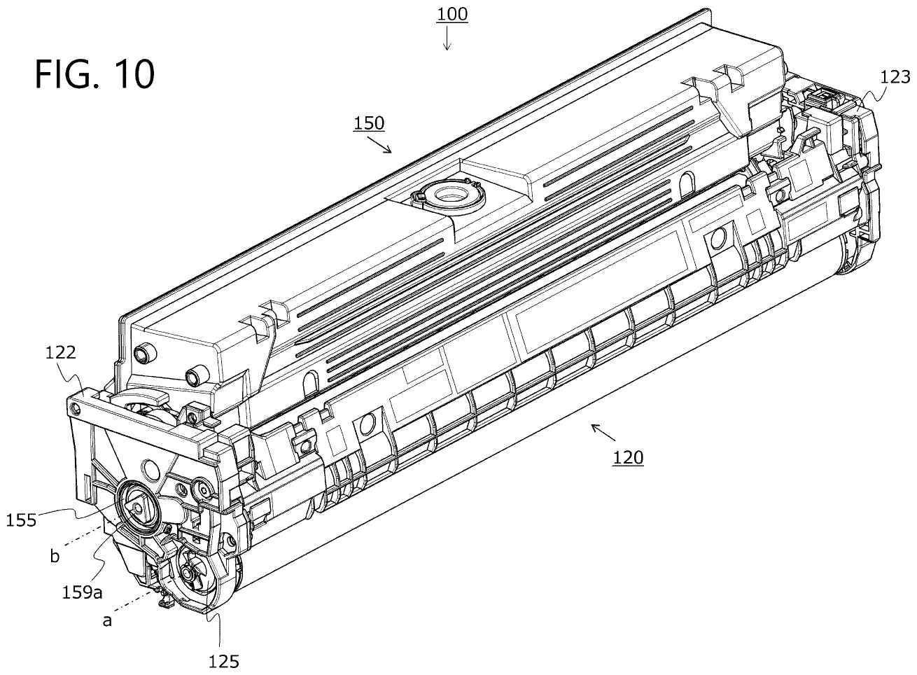

The configuration of the process cartridge will be described with reference to FIGS. 7 to 10. FIG. 7 is a disassembled perspective view of the drum unit 120. FIG. 8 is a disassembled perspective view of the developing unit 150. FIG. 9 is a perspective assembly diagram of the process cartridge 100 from the driving side that is one end side of the axial direction of the photosensitive drum 101. FIG. 10 is a perspective view of the process cartridge 100 as viewed from the driving side.

The process cartridge 100 is equipped with the photosensitive drum 101 and the process means that acts on the photosensitive drum 101. The process means here is the charging roller 102 serving as charging means for charging the photosensitive drum 101, the developing roller 103 serving as developing means for developing latent images formed on the photosensitive drum 101, and so forth. The process cartridge 100 is divided into the drum unit 120 and the developing unit 150.

In the following description, a longitudinal direction Y of the drum unit 120 and the developing unit 150 is a direction that is substantially parallel with a rotation axis line a of the photosensitive drum 101 (FIG. 9).

### Configuration of Drum Unit

As illustrated in FIGS. 7 and 9, the drum unit 120 is made up of the photosensitive drum 101, the charging roller 102, and a drum frame body 121. The charging roller 102 is rotatably supported by a driving-side charging roller bearing 126a and a non-driving-side charging roller bearing 127a, and is biased toward the photosensitive drum 101 by pressure springs 126b and 127b (direction of arrow F in FIG. 3). Also, a driving-side charging roller distancing member 129 and a non-driving-side charging roller distancing member 130 are attached at respective longitudinal end portions, distancing the charging roller 102 from the photosensitive drum 101 in the initial shipping state. The distanced state is disengaged by the photosensitive drum 101 rotating at the time of use.

The photosensitive drum 101 supported is rotatably by a driving-side cartridge cover member 122 and a non-driving-side cartridge cover member 123 that are provided on respective longitudinal-direction ends of the process cartridge 100.

As illustrated in FIG. 9, a coupling member 125 for transmitting driving force to the photosensitive drum 101 is provided on one end side of the photosensitive drum 101 in the longitudinal direction thereof. The coupling member 125 engages a main-body-side drum driving coupling 30 serving as a drum drive output portion of the image forming apparatus main body 2. Driving force of a drive motor (omitted from illustration) of the image forming apparatus main body 2 is transmitted to the photosensitive drum 101, which is rotated in the direction of arrow A in FIG. 3. Also, the photosensitive drum 101 has a drum flange 124 on the other end side in the longitudinal direction. The driving-side charging roller bearing 126a and the non-driving-side charging roller bearing 127a that support the charging roller 102 are supported by the drum frame body 121, such that the charging roller 102 can come into contact with the photosensitive drum 101 and rotate therewith by following the photosensitive drum 101 (direction of arrow E in FIG. 3).

### Configuration of Developing Unit

The developing unit 150 is made up of the developing roller 103, a toner supply roller 104 (supply member), a developing blade 156, a developing frame body (developer container), and so forth, as illustrated in FIGS. 3 and 8.

The developing frame body is made up of a first developing frame body 151 and a second developing frame body 152. The first developing frame body 151 and the second developing frame body 152 are joined by ultrasonic welding or the like. The developing frame body has a toner accommodation portion 162 that accommodates toner to be supplied to the developing roller 103. The developing frame body also rotatably supports the developing roller 103 and the toner supply roller 104 through a driving-side bearing 153 and a non-driving-side bearing 154, and holds the developing blade 156 that regulates a layer thickness of toner on a peripheral face of the developing roller 103. The toner accommodation portion 162 communicates with a developing chamber 174 via an opening portion 175. The toner supply roller 104 and the developing roller 103 are disposed in the developing chamber 174. When usage of the cartridge is started, a seal member on the opening portion 175 is removed, and toner is conveyed from the toner accommodation portion 162 to the developing chamber 174 by rotation of a conveying member 161.

The developing blade 156 is made by attaching an elastic member 156b, which is a metal sheet around 0.1 mm thick, to a bearing member 156a that is a metal material having a letter-L shaped cross-section, by welding or the like. Two positions of the developing blade 156, which are one end side and the other end side in the longitudinal direction, are attached to the developing frame body by fixing screws 156c.

A developing drive input gear 159 for transmitting driving force to the developing unit 150 is provided on one end side of the developing unit 150 in the longitudinal direction thereof. A developing input coupling 159a that receives driving force from a main-body-side developing drive coupling 40 of the image forming apparatus main body 2 is provided on the developing drive input gear 159, whereby driving force of a drive motor (omitted from illustration) of the image forming apparatus main body 2 is input to the developing unit 150.

The driving force input to the developing unit 150 is transmitted to a developing roller gear 157, thereby rotating the developing roller 103 in the direction of arrow C in FIG. 3 and transmitting the driving force to a toner conveying roller gear 158, thus rotating the toner supply roller 104 in a direction of arrow D in FIG. 3. Also, the driving force is transmitted to a stirring gear 160, whereby the conveying member 161 is rotated in a direction of arrow A in FIG. 3, and toner in the toner accommodation portion 162 is stirred.

The conveying member 161 has a rotating shaft portion 161a that is parallel to the rotation axis line direction of the developing roller 103, and stirring sheets 161b and 161c that are sheets that have flexibility. One end of each of the stirring sheets 161b and 161c is attached to the rotating shaft portion 161a, and the other end thereof is a free end. The rotating shaft portion 161a rotates, and the stirring sheets 161b and 161c also rotate in conjunction therewith, whereby the toner is stirred by the stirring sheets 161b and 161c.

A developing cover member 155 for supporting and covering the developing drive input gear 159 is provided to one end side of the developing unit 150 in the longitudinal direction thereof.

### Assembly of Drum Unit and Developing Unit

Assembly of the drum unit 120 and the developing unit 150 will be described with reference to FIG. 9. The drum unit 120 and the developing unit 150 are linked by the driving-side cartridge cover member 122 and the non-driving-side cartridge cover member 123 that are provided on either end of the process cartridge 100 in the longitudinal direction thereof. A developing unit supporting hole 122b for pivotably (movably) supporting the developing unit 150 is provided in the driving-side cartridge cover member 122 that is provided on one end side of the process cartridge 100 in the longitudinal direction thereof. In the same way, a developing unit supporting hole 123b for pivotably supporting the developing unit 150 is provided in the non-driving-side cartridge cover member 123 that is provided on the other end side of the process cartridge 100 in the longitudinal direction thereof.

Further, drum supporting holes 122a and 123a for rotatably supporting the photosensitive drum 101 are respectively provided in the driving-side cartridge cover member 122 and the non-driving-side cartridge cover member 123. Now, at one end side thereof, an outer diameter portion of a cylinder portion 155a of the developing cover member 155 is fit into the developing unit supporting hole 122b of the driving-side cartridge cover member 122. On the other end side thereof, an outer diameter portion of a cylinder portion (omitted from illustration) of the non-driving-side bearing 154 is fit into the developing unit supporting hole 123b of the non-driving-side cartridge cover member 123. Further, both ends of the photosensitive drum 101 in the longitudinal direction thereof are fit into the drum supporting hole 122a of the driving-side cartridge cover member 122 and the drum supporting hole 123a of the non-driving-side cartridge cover member 123, respectively. The driving-side cartridge cover member 122 and the non-driving-side cartridge cover member 123 are fixed to the drum unit 120 by screws, adhesive, or the like, omitted from illustration.

Accordingly, the developing unit 150 is rotatably supported with respect to the drum unit 120 (photosensitive drum 101) by the driving-side cartridge cover member 122 and the non-driving-side cartridge cover member 123, and the developing roller 103 can be positioned at a position for acting on the photosensitive drum 101 when forming images.

A state in which the drum unit 120 and the developing unit 150 are assembled by the above processes and are integrally formed as the process cartridge 100 is illustrated in FIG. 10.

Note that an axis line that connects the center of the developing unit supporting hole 122b of the driving-side cartridge cover member 122 and the center of the developing unit supporting hole 123b of the non-driving-side cartridge cover member 123 will be referred to as “pivoting axis b”. Now, the cylinder portion 155a of the developing cover member 155 on one end side is coaxial with the developing input coupling 159a. That is to say, the developing unit 150 has a configuration in which driving force is transmitted from the image forming apparatus main body 2 at this pivoting axis b. Also, the developing unit 150 is turnably supported about the pivoting axis b.

### Configuration of Remaining Toner Amount Sensing

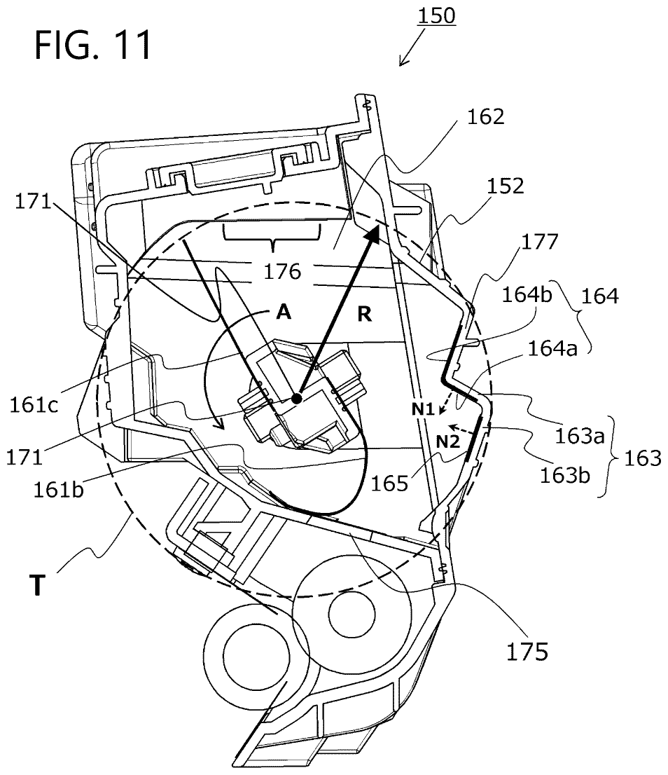

A configuration for sensing the remaining toner amount (developer amount) in the developing unit 150 (in the accommodation chamber) will be described with reference to FIGS. 11 to 15A to 15C. FIGS. 11, 13A to 13C, and 14A to 14C are cross-sectional views of the developing unit 150. All cross-sectional views in the present embodiment, including these, are cross-sectional views of the process cartridge 100 in an orientation of being attached to the image forming apparatus main body 2, and the members in the drawings are in orientations of being used for image formation. In these drawings, an up-down direction of the drawings matches the gravitational direction. These drawings are cross-sectional views that are perpendicular to a conveying member rotation axis line 171.

The developing unit 150 is provided with a remaining amount sensing portion 163 (sensing portion), which includes a first conducting member 164 and a second conducting member 165. The first conducting member 164 is provided on a wall face 163a (first inner wall face) of the frame body of the developing unit 150, and the second conducting member 165 is provided on a wall face 163b (second inner wall face) that is adjacent to the wall face 163a. In the present embodiment, electrostatic capacitance that corresponds to the amount of developer between the first conducting member 164 and the second conducting member 165 is sensed.

Now, for a detecting material of the remaining amount sensing portion 163, a metal plate of stainless steel or the like, a sheet member of conductive resin or the like, or suchlike, which enables detection of electrostatic capacitance, is used. In the present embodiment, a conductive resin sheet, obtained by dispersing in resin carbon black that is a conductive material, is used. In the following description, description will be made using conducting members that are a form of the detecting material.

### Configuration of Remaining Amount Sensing Portion of Toner Accommodation Portion

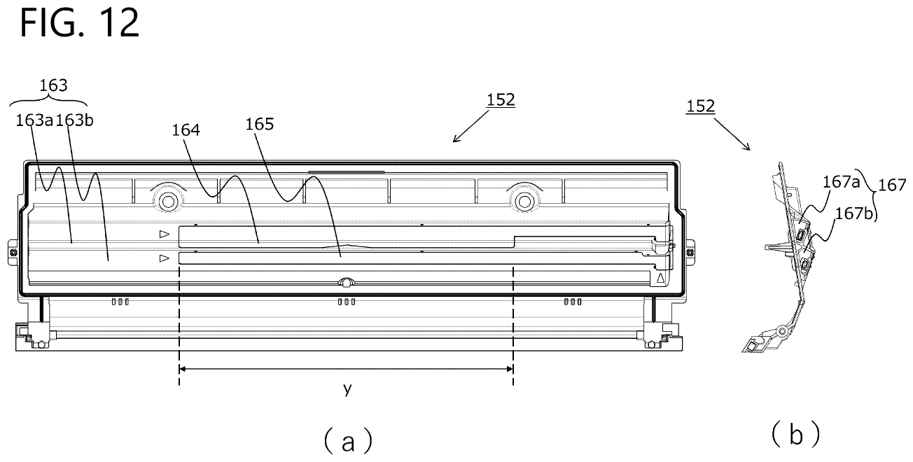

A configuration of the remaining amount sensing portion 163 that is provided in a recessed portion of the toner accommodation portion 162 will be described with reference to FIGS. 11, 12A, and 12B.

FIG. 11 is a cross-sectional view of the developing unit 150, taken at position P-P in FIG. 8. As illustrated in FIG. 11, a recessed portion that is recessed from the inner side of the toner accommodation portion 162 toward the outer side thereof is formed in a face of the second developing frame body 152 on the toner accommodation portion 162 side (equivalent to inner wall face of the developing unit 150). Two adjacent faces, which are the wall face 163a and the wall face 163b, make up this recessed portion where the remaining amount sensing portion 163 is provided. The first conducting member 164 is provided to the wall face 163a, and the second conducting member 165 is provided to the wall face 163b. Now, with the rotation direction of the conveying member 161 as rotation direction A, the wall face 163a is the wall on the downstream side in the rotation direction A of the conveying member 161, and the wall face 163b is the wall on the upstream side in the rotation direction A of the conveying member 161.

Also, the position of the recessed portion formed in the toner accommodation portion 162 by the wall faces 163a and 163b will be described. Now, in FIG. 11, a region of an inner wall face of the toner accommodation portion 162 that is on an opposite side from the opening portion 175 across the conveying member rotation axis line 171 is illustrated as a first region 176. The opening portion 175 in the present embodiment is at a lower portion of the toner accommodation portion 162, for communication of the toner accommodation portion 162 with the developing chamber 174 that is below. Accordingly, the first region 176 is situated at an upper portion of the inner wall faces of the toner accommodation portion 162. In the rotation direction A of the conveying member 161, the wall faces 163a and 163b that make up the recessed portion are situated at inner wall faces that are on the downstream side from the opening portion 175 and also are on the upstream side of the first region 176.

The angle of the wall face 163a on which the first conducting member 164 is provided as to a horizontal plane is an angle at which toner loaded on the first conducting member 164 falls down under its own weight. Also, the angle of the wall face 163b on which the second conducting member 165 is provided as to a horizontal plane is an angle at which toner loaded on the second conducting member 165 slides down under its own weight. That is to say, in a case in which toner enters the remaining amount sensing portion 163, the toner is discharged from the remaining amount sensing portion 163 under its own weight, excluding the portion thereof that is conveyed out from inside the remaining amount sensing portion 163 by the stirring sheets 161b and 161c.

In the present embodiment, the normal N1 of the wall face 163a faces downward with respect to a horizontal plane, and accordingly toner falls down. Also, the normal N2 of the wall face 163b faces upward with respect to a horizontal plane, but the angle of the wall face 163b is an inclination angle no smaller than the angle of repose of the toner. Accordingly, inclining the wall face 163b at an angle no smaller than the angle of repose of the toner causes toner loaded on the wall face 163b to slide down the wall face 163b under its own weight. The angles of each of the wall face 163a and the wall face 163b with respect to a horizontal plane are not limited to these, and it is sufficient to be angles at which the toner falls under its own weight.

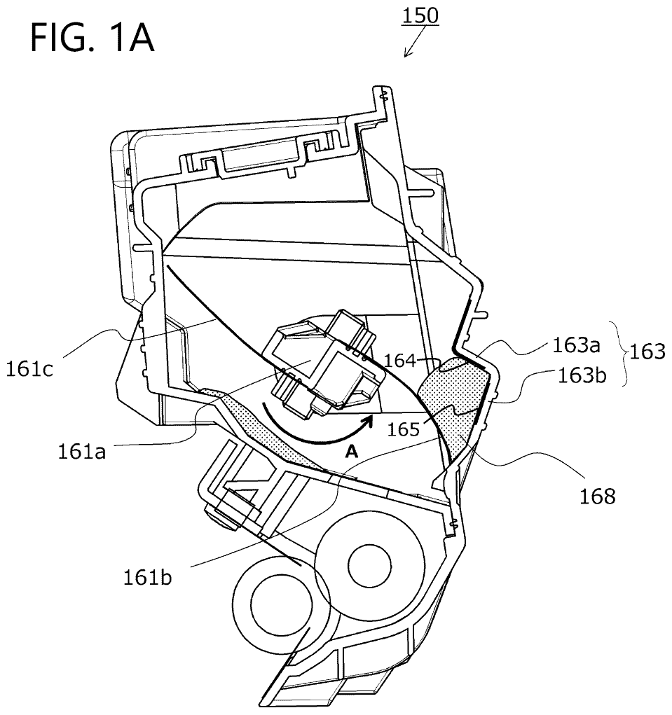

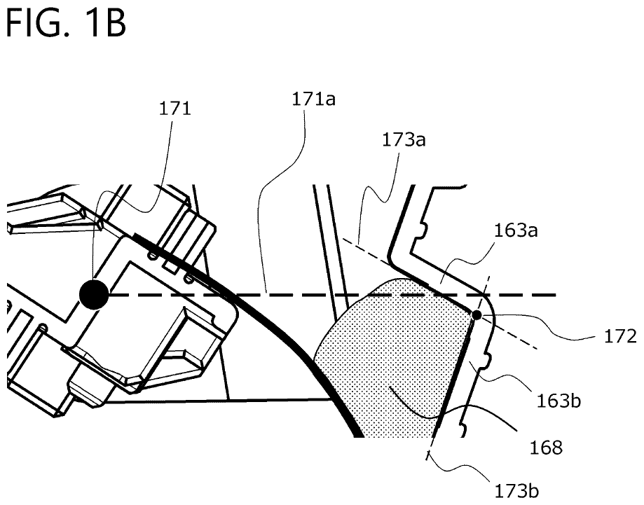

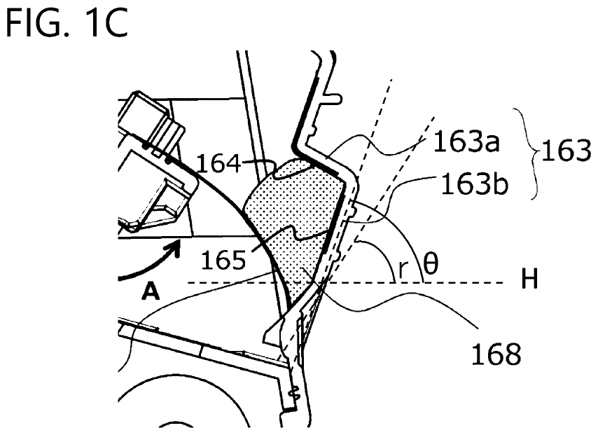

An example of the configuration of the remaining amount sensing portion 163 will be described with reference to a partially enlarged cross-sectional view in FIG. 1C. With the angle of repose as r here, when toner is piled up to form a mountain, the angle of repose r is an angle that is an angle formed by a slope of the toner and a slope of the mountain, and indicates the greatest angle at which the toner can be stably maintained without spontaneously collapsing. Accordingly, the toner will not collapse as long as the angle of the slope of the toner with respect to a horizontal line H is no greater than the angle of repose r. Conversely, an angle θ of the wall face 163b with respect to the horizontal line H is no smaller than the angle of repose r in FIG. 1C, and accordingly the toner loaded on the wall face 163b slides down under its own weight. The angle of repose r of the toner used in the present embodiment is approximately 40°, and accordingly the angle θ of the wall face 163b needs to exceed 40° at the least, and preferably is no smaller than 50°. The actual angle θ in FIG. 1C is 70.8°. Note that the fluidity changes in accordance with difference in the type of toner (e.g., difference in surface properties due to adhesion of external additives), and the higher the fluidity of the toner is, the smaller the angle of repose is. Accordingly, the angle θ may be changed in accordance with the toner of which usage is assumed.

Also, as illustrated in the cross-sectional view in FIG. 11, at least part of the recessed portion where the remaining amount sensing portion 163 is provided is on an inner side of an imaginary circle T. The imaginary circle T is the perimeter of a circle of which the conveying member rotation axis line 171 is the center and the radius is R. The radius R here is equivalent to a free length of the stirring sheets 161b and 161c (a length assuming that the sheets having flexibility are not flexed). Of the end portions of each of the stirring sheets 161b and 161c, the side connected to the rotating shaft portion 161a is one end, and the end portion on the other side is the other end. The imaginary circle There is an imaginary rotation path traced by the distal end at the other end side of the stirring sheets 161b and 161c.

According to this configuration, the distal end sides of the stirring sheets 161b and 161c come into contact with at least part of the remaining amount sensing portion 163 in a sure manner. At this time, the stirring sheets 161b and 161c that have flexibility bend while the distal ends thereof come into contact with the remaining amount sensing portion 163 provided on the inner periphery of the frame body. This is due to the free length of the stirring sheets 161b and 161c in the cross-sectional view being longer than the distance from the one end to at least part of the remaining amount sensing portion 163. The entire recessed portion may be on the inner side of the imaginary circle T as illustrated in FIG. 11, as a matter of course.

The stirring sheets 161b and 161c then pass the remaining amount sensing portion 163 while coming into contact with the first conducting member 164 and the second conducting member 165, in conjunction with the rotation of the conveying member 161. The length of the remaining amount sensing portion 163 in the longitudinal direction (Y direction) of the developing unit 150 is longer than the length of the stirring sheets 161b and 161c in the Y direction. Due to the stirring sheets 161b and 161c coming into contact with the first conducting member 164 and the second conducting member 165 during the time of this passing, toner is removed from surfaces of the first conducting member 164 and the second conducting member 165. Accordingly, toner can be further removed from the remaining amount sensing portion 163, in addition to the toner falling under gravity.

Note that, as illustrated in FIG. 11, the first conducting member 164 includes not only a first portion 164a that is disposed on the wall face 163a making up the recessed portion, but also a second portion 164b that is disposed on a wall face 177 (third inner wall face) connected upward from the wall face 163a (i.e., on the side opposite from the wall face 163b with the wall face 163a interposed therebetween). The wall face 177 extends in a direction intersecting the wall face 163a, and is provided in the frame body such that a face thereof faces upward. The wall face 177 is provided upward from the wall face 163a and the recessed portion including the wall face 163a with respect to the gravitational direction, and with respect to the rotation direction A, is provided on the downstream side from the wall face 163a and also on the upstream side from the first region 176. The angle of the wall face 177 with respect to a horizontal plane is preferably an inclination angle that is no smaller than the angle of repose of the toner, in order to suppress retention of toner.

Next, the two conducting members (first conducting member 164 and second conducting member 165) that are provided to the remaining amount sensing portion 163 will be described with reference to FIGS. 12A and 12B. FIG. 12A is a diagram viewing the second developing frame body 152 from the toner accommodation portion 162 side in FIG. 8, and FIG. 12B is a side view of FIG. 12A.

The first conducting member 164 and the second conducting member 165 are applied up to one end portion of the second developing frame body 152 in the longitudinal direction thereof, without coming into contact with each other. Note that the portion of closest proximity between the first conducting member 164 and the second conducting member 165 is limited to a range y that is symmetrical as to a center in the longitudinal direction. At the one end portion in the longitudinal direction, a first conductive resin contact point 167a and a second conductive resin contact point 167b are formed on the second developing frame body 152 by two-shot molding. The first conductive resin contact point 167a and the first conducting member 164 come into contact, and the second conductive resin contact point 167b and the second conducting member 165 come into contact, thereby conducting between the inside and the outside of the developing unit 150.

The first conducting member 164 and the second conducting member 165 are then connected to the image forming apparatus main body 2 through the non-driving-side bearing 154 illustrated in FIG. 8, via the first conductive resin contact point 167a and the second conductive resin contact point 167b. Accordingly, voltage can be applied to the first conducting member 164 and the second conducting member 165. According to the above configuration, the first conducting member 164 and the second conducting member 165 serve roles as electrode plates, forming a capacitor inside the developing unit 150.

The range of the recessed portion including the wall faces 163a and 163b, the first conducting member 164, and the second conducting member 165 may be conceived as being the remaining amount sensing portion 163, or the control unit 250 that calculates the remaining toner amount on the basis of signals obtained by the first conducting member 164 and the second conducting member 165 may further be included and conceived as being the remaining amount sensing portion 163.

### Description of Entry/Exit of Toner to/from Remaining Amount Sensing Portion

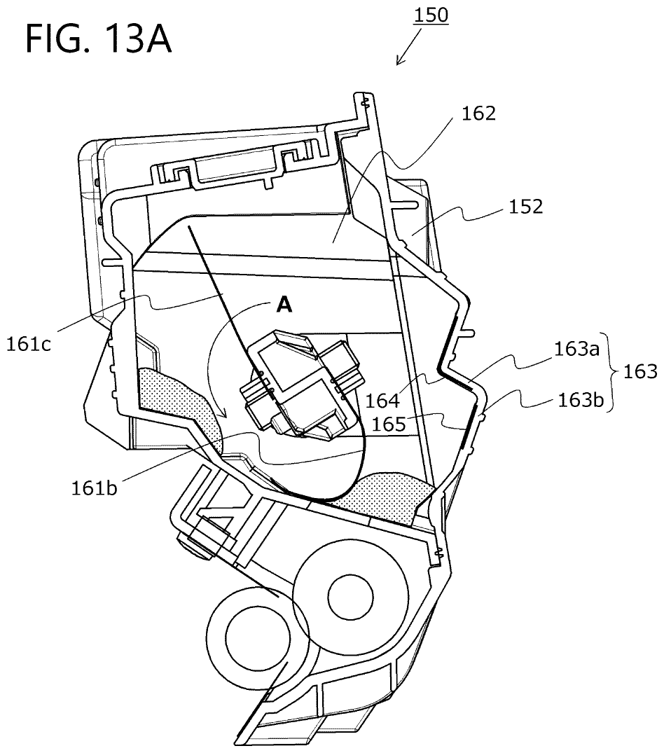

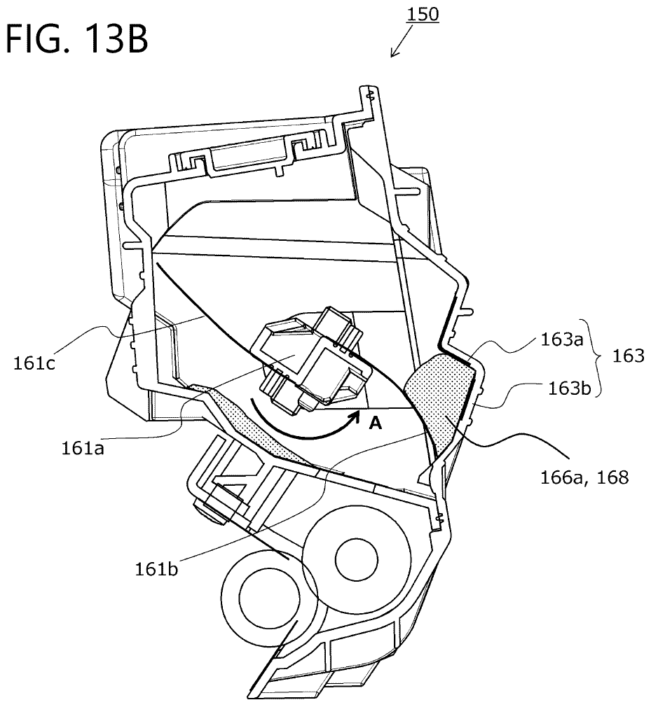

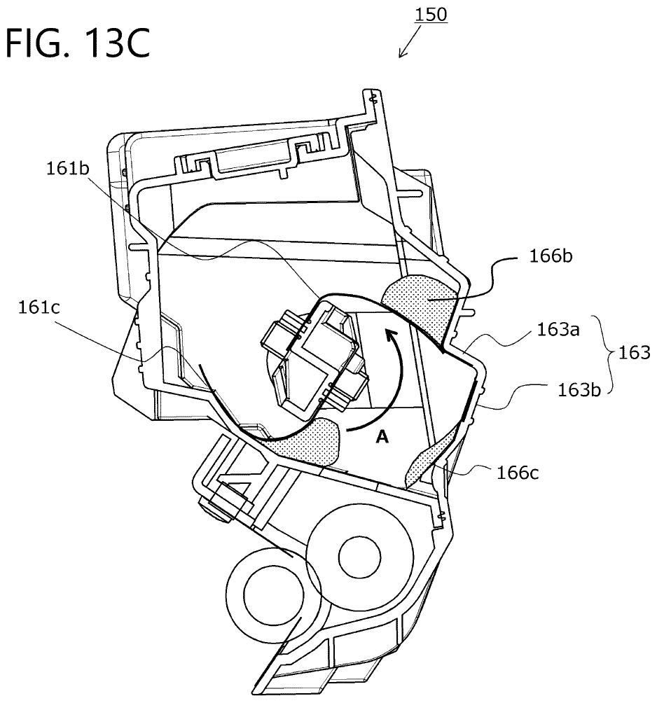

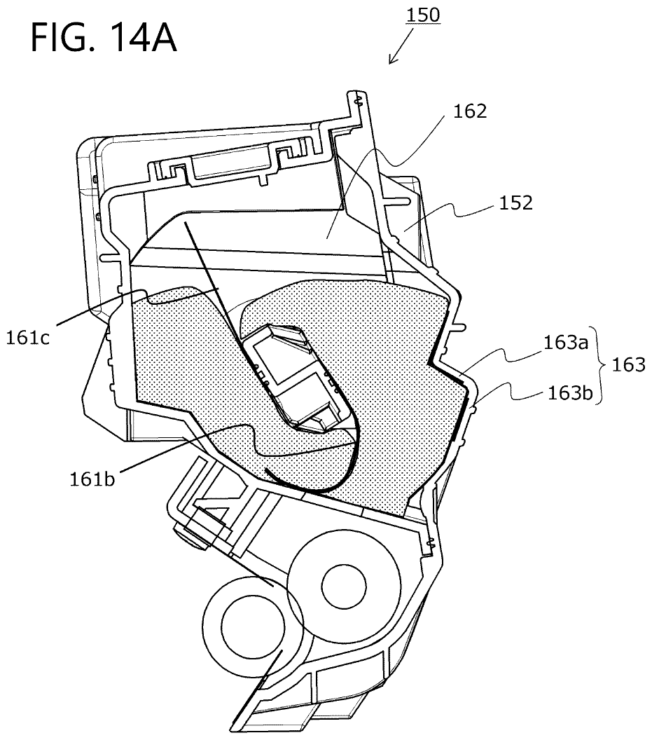

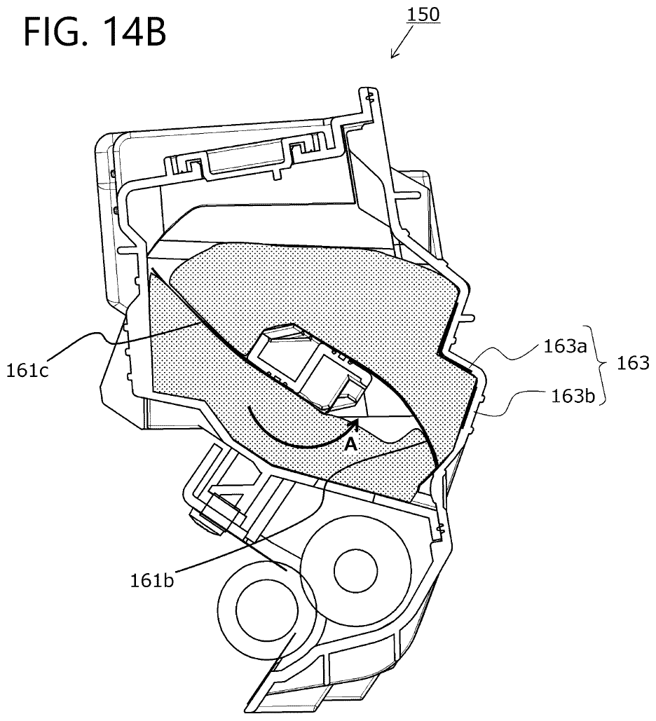

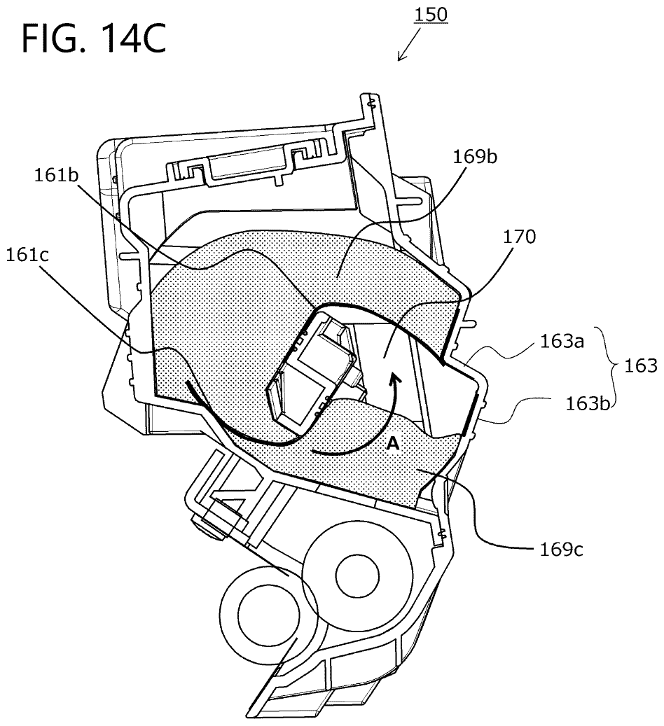

The way in which toner is conveyed by the conveying member 161 will be described with reference to cross-sectional views of the developing unit in FIGS. 13A to 13C and 14A to 14C. FIGS. 13A to 13C illustrate the way in which toner is conveyed to the remaining amount sensing portion 163 by the conveying member 161 when the remaining amount of toner is small.

In the drawings, conveyed toner 166 is toner that is conveyed by the stirring sheet 161b or 161c. In particular, FIG. 13B illustrates conveyed toner 166a that is passing through the remaining amount sensing portion, and FIG. 13C illustrates conveyed toner 166b that is on the stirring sheet after passing through the remaining amount sensing portion and conveyed toner 166c that has fallen under its own weight after passing through the remaining amount sensing portion. Also, FIG. 13B illustrates conveyed toner 168 at the time of being conveyed into the remaining amount sensing portion, and FIG. 14C illustrates conveyed toner 169b that is being conveyed by the stirring sheet 161b, conveyed toner 169c that is being conveyed by the stirring sheet 161c, and no-toner space 170.

FIG. 13A is cross-sectional view of the developing unit 150 taken along P-P in FIG. 8, in a state immediately before the stirring sheet 161b conveying toner into the remaining amount sensing portion 163 in conjunction with the conveying member 161 rotating in the direction A. Next, FIG. 13B is a cross-sectional view illustrating toner distribution at the instant at which the stirring sheet 161b passes the remaining amount sensing portion 163 and the conveyed toner 166a is sensed.

Thus, the state here is a state in which toner has entered into the remaining amount sensing portion 163 by the toner being lifted by the stirring sheet 161b. Now, the distal end of the stirring sheet 161b comes into contact with the inner walls of the wall faces 163a and 163b (the first conducting member 164 and the second conducting member 165), and accordingly the toner is compressed, and is pressed into the remaining amount sensing portion 163 without falling off from the stirring sheet 161b.

Next, FIG. 13C is a cross-sectional view illustrating toner distribution in a state immediately following passing the remaining amount sensing portion 163 due to the conveying member 161 further rotating in the direction A from the state in FIG. 13B. Thus, part of the conveyed toner 166b is raised upward by the stirring sheet 161b, and part of the conveyed toner 166c falls under its own weight and is discharged from the remaining amount sensing portion 163.

FIGS. 14A to 14C illustrate the way in which toner is conveyed to the remaining amount sensing portion 163 by the conveying member 161 when the remaining amount of toner is great. The phases of the conveying member 161 in FIGS. 14A to 14C are the same phases as those in FIGS. 13A to 13C, respectively.

FIG. 14A is cross-sectional view illustrating toner distribution in a state immediately before the stirring sheet 161b conveying toner into the remaining amount sensing portion 163 in conjunction with the conveying member 161 rotating in the direction A. Unlike in FIG. 13A, the remaining toner amount here is great, and accordingly the remaining amount sensing portion 163 is already in a state of having been filled with toner at this point.

Next, FIG. 14B is a cross-sectional view illustrating toner distribution at the instant of the stirring sheet 161b pressing toner into the remaining amount sensing portion 163.

Next, FIG. 14C is a cross-sectional view illustrating toner distribution in a state immediately following the stirring sheet 161b passing the remaining amount sensing portion 163. The state here is a state in which toner is discharged from between the first conducting member 164 and the second conducting member 165, and the no-toner space 170 is generated. Thus, there is a characteristic in which the amount of time of toner being present in the remaining amount sensing portion 163 is long when the remaining toner amount is great, as compared to when the remaining toner amount is small.

### Method of Sensing Remaining Toner Amount

The dielectric constant of toner is higher than the dielectric constant of air, and accordingly when toner enters between the first conducting member 164 and the second conducting member 165, the electrostatic capacitance between the first conducting member 164 and the second conducting member 165 increases. Accordingly, in a case of toner conveyed by the stirring sheets 161b and 161c passes between the first conducting member 164 and the second conducting member 165 as in FIG. 13B, the electrostatic capacitance between the first conducting member 164 and the second conducting member 165 increases.

Conversely, in a case in which the stirring sheets 161b and 161c pass through the remaining amount sensing portion 163 as illustrated in FIG. 13C, and toner between the first conducting member 164 and the second conducting member 165 is either conveyed out by the stirring sheets 161b and 161c or falls under its own weight, the electrostatic capacitance between the first conducting member 164 and the second conducting member 165 decreases. As described above, voltage is then applied to the first conducting member 164 via the first conductive resin contact point 167a, and change in voltage based on change in electrostatic capacitance is sensed via the second conductive resin contact point 167b that is connected to the second conducting member 165.

As described above, the amount of time over which toner is present in the remaining amount sensing portion 163 changes in accordance with the remaining toner amount. Accordingly, the remaining toner amount can be identified by the control unit 250 sensing the change in time, and referencing a table indicating a correlative relation between change in time and remaining toner amount that is saved in memory.

Now, there is demand for further improvement in sensing precision of remaining toner amount by the present remaining amount sensing system. As a configuration to that end, details of stabilizing the sensed toner amount when the remaining toner amount is small will be described next. Also, when the remaining toner amount is great, the remaining amount sensing portion 163 is readily filled in by toner and change in electrostatic capacitance tends to be difficult to obtain, as described above. A configuration that enables remaining amount sensing in such cases as well will also be described.

### Placement of Remaining Amount Sensing Portion to Stabilize Sensed Toner Amount

As described earlier, remaining amount sensing is a system for notifying the user that the toner amount is low, and accordingly there is demand for improved sensing precision when the remaining toner amount is small. Remaining toner amount sensing is processing for estimating the total remaining amount within the developing unit 150 by sensing the amount of toner conveyed into the remaining amount sensing portion 163 by the stirring sheets 161b and 161c. Accordingly, in order to improve sensing precision, the amount of toner that the stirring sheets 161b and 161c convey into the remaining amount sensing portion 163 each time needs to be stable.

A solution to the above issue by the present embodiment will be described with reference to FIGS. 1A and 1B. FIG. 1A is a cross-sectional view taken in a direction perpendicular to the conveying member rotation axis line 171, illustrating toner distribution in a state of pressing toner into the remaining amount sensing portion 163 when the remaining toner amount is small. FIG. 1B is an enlarged view of the vicinity of the remaining amount sensing portion 163 in FIG. 1A.

As illustrated in FIG. 1A, in the configuration of the present embodiment, the conveyed toner 168 at the time of conveying into the remaining amount sensing portion 163 is distributed disproportionally on the stirring sheet 161b toward the distal end side of the stirring sheet 161b (opposite side from the rotating shaft portion 161a) when the remaining toner amount is small. This is due to the stirring sheet 161b being oriented monotonically downward the further toward the distal end side thereof from the rotating shaft portion 161a side when conveying toner into the remaining amount sensing portion 163, since the remaining amount sensing portion 163 is downward from the rotating shaft portion 161a of the conveying member 161.

FIG. 1B illustrates a specific placement of the remaining amount sensing portion 163. The conveying member rotation axis line 171 indicates the rotation axis of the rotating shaft portion 161a. An up-down direction position 171a is an extension line in a horizontal direction, indicating the position of the conveying member rotation axis line 171 in the up-down direction (gravitational direction). An intersection 172 at which a first imaginary line 173a that passes through the wall face 163a and a second imaginary line 173b that passes through the wall face 163b intersect is illustrated in the cross-sectional view in FIG. 1B. This intersection 172 is a point included in a remaining amount sensing portion imaginary line, that is a line of intersection of a plane including the wall face 163a and a plane including the wall face 163b.

In the configuration according to the present embodiment, the intersection 172 is provided downward from the up-down direction position 171a that indicates the same height as the conveying member rotation axis line 171, and this is expressed as “the remaining amount sensing portion 163 is downward from the conveying member 161”. Note that the remaining amount sensing portion 163 may have a curvature at the line of intersection of the wall face 163a and the wall face 163b.

Now, a hypothetical case in which the remaining amount sensing portion 163 is upward from the conveying member 161 (i.e., a case in which the intersection 172 is upward from the up-down direction position 171a) will be assumed. In this case, the orientation of the stirring sheet 161b will be closer to a horizontal orientation at the time of conveying toner into the remaining amount sensing portion 163. Accordingly, the conveyed toner 168 is not distributed disproportionally on the stirring sheet 161b toward the distal end side thereof, and a phenomenon can occur in which the conveyed toner 168 spreads over the stirring sheet 161b or spills off the stirring sheet 161b toward the rotating shaft portion 161a side. At this time, the toner amount conveyed into the remaining amount sensing portion 163 each time will become unstable, and remaining amount sensing precision will deteriorate. Conversely, in a case of the configuration in which the remaining amount sensing portion 163 is downward with respect to the conveying member 161 as in the present embodiment, the toner amount conveyed into the remaining amount sensing portion 163 can be further stabilized, since the conveyed toner 168 is distributed disproportionally on the stirring sheet 161b toward the distal end side. Thus, the remaining toner amount that is calculated stabilizes as a result, and the remaining amount sensing precision when the remaining toner amount is small improves.

Note that this effect is brought about by the position of the remaining amount sensing portion 163. Accordingly, there is no need to provide a plurality of sheets such as with the stirring sheets 161b and 161c in the present embodiment in order to yield this effect, and a single stirring sheet is sufficient for the effect to be obtained.

Although the remaining amount sensing portion 163 is formed by two planes provided in the frame body in the present embodiment, the present invention can be applied as long as the configuration is such that the remaining amount sensing portion 163 can be evaluated as being downward from the conveying member 161. For example, the cross-section thereof may be a curved line like an arc or the like. In that case, for example, a configuration is preferably made in which the intersection 172 of the remaining amount sensing portion imaginary line is set at an intermediate point between the end portion of the first conducting member 164 and the end portion of the second conducting member 165 in the cross-section, such that the intersection 172 is downward from the up-down direction position 171a.

### Conveying Member Configuration That Broadens Range of Remaining Toner Amount in Which Remaining Amount Can Be Sensed

As described earlier, the remaining amount sensing system obtains the amount of change in electrostatic capacitance of the first conducting member 164 and the second conducting member 165 that changes with respect to reduction in the remaining toner amount. Accordingly, in order to broaden the range of the remaining toner amount in which the remaining amount can be sensed, there is a need to enable remaining amount sensing even when the remaining toner amount is great, which is a situation in which the remaining amount sensing portion 163 tends to be readily filled in with toner and change in the electrostatic capacitance is not readily obtained. To this end, being able to convey toner out from the remaining amount sensing portion 163 is necessary.

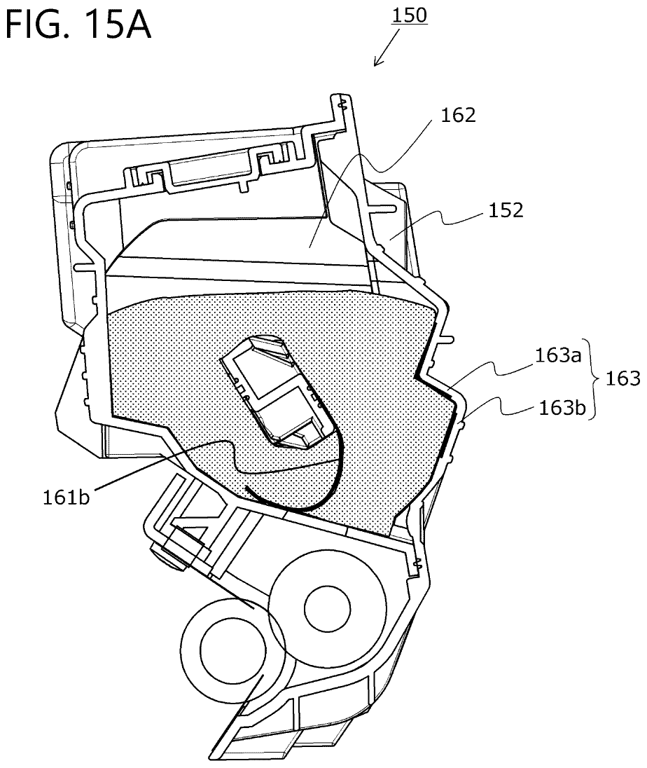

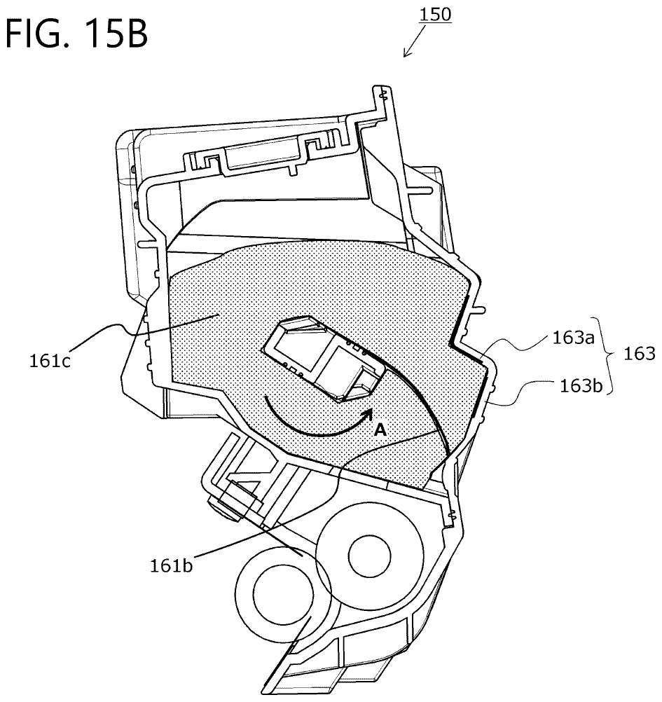

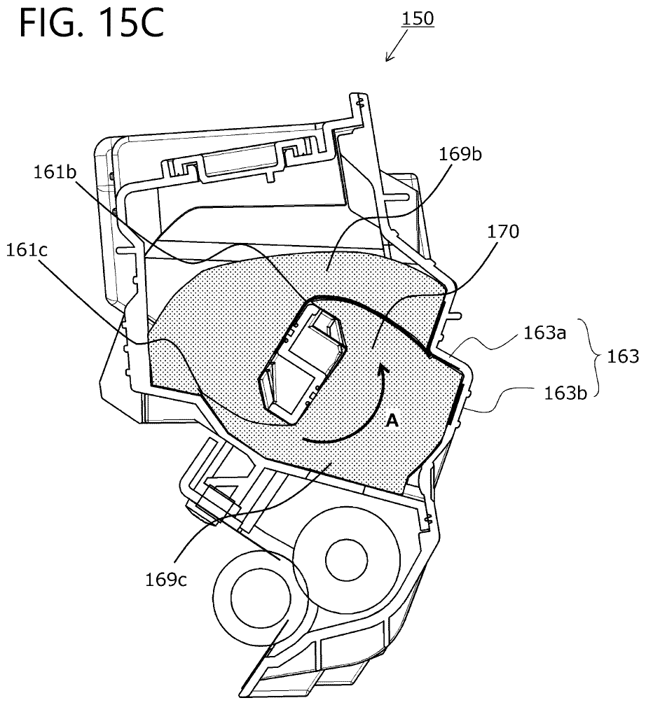

In the present embodiment, the range over which the remaining amount can be sensed is broadened by providing two stirring sheets to the conveying member 161. This will be described in detail with FIGS. 14C and 15A to 15C. FIG. 14C is a cross-sectional view illustrating toner distribution at the time of conveying toner out from the remaining amount sensing portion 163, when the remaining toner amount is great, as described earlier.

As described so far, in the configuration of the preset embodiment, the two stirring sheets 161b and 161c are provided to the rotating shaft portion 161a in the conveying member 161. Accordingly, toner within the developing unit 150 is divided into the two of the conveyed toner 169b that is being conveyed by the stirring sheet 161b, and the conveyed toner 169c that is being conveyed by the stirring sheet 161c, as illustrated in FIG. 14C.

At this time, immediately following the stirring sheet 161b passing the remaining amount sensing portion 163, the no-toner space 170 is formed on the downstream side of the stirring sheet 161b, as illustrated in FIG. 14C. This is a phenomenon in which the stirring sheet 161b serves as a roof at the phase of the conveying member 161 in FIG. 14C and prevents the conveyed toner 169b from falling in the vicinity of the remaining amount sensing portion 163, and also in which the stirring sheet 161c dams the flow of the conveyed toner 169b in the counterclockwise direction in the drawing under its own weight, is as to suppress toner from flowing into the vicinity of the remaining amount sensing portion 163. By the remaining amount sensing portion 163 sensing the no-toner space 170 formed in this way, change in electrostatic capacitance can be obtained even when the remaining toner amount is great.

### Comparative Example

Now, the way in which toner is conveyed to the remaining amount sensing portion 163 in a case of using a conveying member 161 with a different configuration from that in FIGS. 14A to 14C will be described. In the present comparative example, description will be made regarding a case in which the number of stirring sheets is one. FIGS. 15A to 15C are cross-sectional views illustrating the way in which toner is conveyed in a case in which the number of stirring sheets is one (only the stirring sheet 161b), and the respective phases are the same as those in FIGS. 14A to 14C.

In the present comparative example, doing away with the stirring sheet 161c causes conveyed toner 168b to flow in the counterclockwise direction in the drawing. At this time, toner flows into the remaining amount sensing portion 163 immediately following the stirring sheet 161b passing the remaining amount sensing portion 163, and accordingly there is no formation of the no-toner space 170 and the remaining amount sensing portion 163 continues to be filled with toner throughout FIGS. 15A to 15C. That is to say, no change in electrostatic capacitance occurs, and accordingly sensing of the remaining toner amount cannot be performed.

Conversely, with the present embodiment, the number of stirring sheets is two (a plurality of sheets), and accordingly the no-toner space 170 is temporarily formed even when the remaining toner amount is great, change in electrostatic capacitance can be sensed, and thus the range of the remaining toner amount over which the remaining amount can be sensed is broadened.

Providing a plurality of stirring sheets can yield the greater effects of the range over which sensing can be performed being broadened than providing one stirring sheet, regardless of the installation angle thereof, but identifying the installation angle is more preferable. For example, in a case in which the number of the stirring sheets is two as in the present embodiment, as illustrated in the cross-sectional views in FIG. 14A and other drawings, the stirring sheets 161b and 161c are preferably installed in opposite direction to each other with respect to the conveying member rotation axis line 171. That is to say, the installation direction of the stirring sheet 161b (the direction from the one end connected to the conveying member rotation axis line 171 toward the other end that is the distal end), and the installation direction of the stirring sheet 161c, are preferably differentiated by 180°. Accordingly, the no-toner space 170 that is temporarily formed can be maximized.

Installation directions in a case in which the number of the stirring sheets is two will be studied. In the present embodiment, the stirring sheet 161b (first sheet) and the stirring sheet 161c (second sheet) are respectively disposed on one region 162a and the other region 162b that are separated by H, which is the imaginary line passing through the conveying member rotation axis line 171, as illustrated in FIG. 3. While the imaginary line is horizontal here, the direction of the imaginary line is not limited to this.

Also, expanding the above description to a case in which the number of the stirring sheets is N sheets (N is an integer of 2 or greater), the installation directions of the stirring sheets are preferably differentiated by an angle obtained by dividing 360° into N parts. That is to say, the installation directions of a first stirring sheet and a second stirring sheet that is adjacent to the first stirring sheet preferably differ by (360/N)°.

As described above, according to the present proposal, the remaining amount sensing portion 163 is disposed downward from the conveying member 161, whereby the stirring sheets 161b and 161c incline downward from the rotating shaft portion 161a toward the distal end side thereof when passing through the remaining amount sensing portion 163. Accordingly, even in a state in which the remaining toner amount within the toner cartridge decreases and the conveying amount decreases, the toner is distributed disproportionally toward the distal end side of the stirring member without falling off the stirring member toward the rotating shaft portion 161a of the conveying member 161. Thus, the toner can be conveyed into the remaining amount sensing portion 163 in a stable manner. Accordingly, the toner amount in the remaining amount sensing portion 163 is stabilized, and the sensing precision is improved even when the remaining toner amount is small. Further, using the plurality of stirring sheets as illustrated in the embodiment enables the no-toner space 170 to be formed around the remaining amount sensing portion 163 even in a case in which the remaining toner amount is great, and sensing precision improves.

Remaining toner amount sensing that uses electrostatic capacitance has been described in the above embodiment. However, the effect described above can also be obtained in optical-type remaining amount sensing in which a light emitting portion and a light receiving portion are provided across a detection window provided to the toner accommodation portion 162, and the remaining amount is detected on the basis of the duration of the light receiving portion receiving light. That is to say, by the remaining amount sensing portion 163 being provided downward with respect to the conveying member 161, toner does not spill off the stirring sheets 161b and 161c at the time of conveying the toner to the remaining amount sensing portion 163 provided in the developing frame body, even in cases in which the remaining toner amount is small.

The configuration of the present proposal can be applied to a developer container or a developing frame body that accommodates developer (toner) to be used for forming images on the recording medium 3, and that is used in an image forming apparatus. Also, the configuration of the present proposal can be applied to a developing apparatus (developing unit) that includes the developer container and that develops electrostatic latent images formed on the photosensitive drum 101. Further, the configuration of the present proposal can be applied to an image forming apparatus that includes the developer container and the developing apparatus.

Also, the configuration according to the present proposal can be applied to a process cartridge that forms developer images on the photosensitive drum 101 and that is also detachably attachable to the apparatus main body of the image forming apparatus 1, and to a toner cartridge or a developing cartridge and is equipped with a developer container that is capable of accommodating developer. Also, the configuration according to the present proposal can be applied to the image forming apparatus 1 that is equipped with an apparatus main body to which these cartridges are detachably attachable and that forms images on the recording medium 3 using the developer within the developer container. In a case of applying the present proposal to these cartridges, it is a prerequisite for the positional relations among the components described above (e.g., relations with respect to the gravitational direction, positional relations in the up-down direction, etc.) to be such that the cartridges are in the orientations of being attached to the image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057906, filed on Mar. 29, 2024, which is hereby incorporated by reference herein in its entirety.

What is claimed is:

1. A developing apparatus, comprising:
an accommodation portion configured to accommodate a developer;
a conveying member that is provided in the accommodation portion, and that has a shaft portion that is rotatably supported about a rotation axis line and a sheet that is flexible and is connected to the shaft portion, wherein the conveying member is configured to convey the developer with the sheet in conjunction with rotation of the shaft portion; and
a sensing portion that includes a first conducting member and a second conducting member provided in the accommodation portion, wherein the sensing portion is configured to sense electrostatic capacitance, in accordance with an amount of developer, between the first conducting member and the second conducting member, wherein
a frame body of the accommodation portion is provided with a recessed portion including (i), in a cross-section that is perpendicular to the rotation axis line, a first inner wall face which constitutes the accommodation portion and on which the first conducting member is provided, and (ii) a second inner wall face which extends in a direction intersecting the first inner wall face and also is adjacent to the first inner wall face and on which the second conducting member is provided, wherein the recessed portion is recessed from an inner side toward an outer side of the accommodation portion,
in a case where the developing apparatus is oriented for use in image formation in an image forming apparatus, the first inner wall face is oriented downward, and the second inner wall face is oriented upward and also has an inclination angle that is greater than or equal to an angle of repose of the developer, and
in the cross-section, an intersection where a first imaginary line that passes through the first inner wall face and a second imaginary line that passes through the second inner wall face intersect is downward from the rotation axis line.

2. The developing apparatus according to claim 1, further comprising a developing chamber configured to communicate with the accommodation portion via an opening portion, and to which the developer accommodated in the accommodation portion is supplied from the opening portion,
wherein, when, among the inner wall faces of the accommodation portion, a region that is on an opposite side to the opening portion across the rotation axis line is a first region, the recessed portion is positioned, in a rotation direction of the conveying member, on a downstream side of the opening portion and on an upstream side of the first region.

3. The developing apparatus according to claim 1,
wherein, assuming that the shaft portion rotates while the sheet is not flexed, and defining an imaginary circle as a rotation path traced by a distal end on a side of the sheet that is not connected to the shaft portion, the recessed portion is on an inner side of the imaginary circle.

4. The developing apparatus according to claim 1,
wherein the conveying member has at least two of the sheets.

5. The developing apparatus according to claim 4,
wherein, in a case where a count of the sheets is N sheets (where N is an integer of 2 or greater), directions of installation of the sheets that are adjacent to each other differ by (360/N)°.

6. The developing apparatus according to claim 1, wherein
the frame body further includes a third inner wall face that extends in a direction intersecting the first inner wall face and is adjacent to the first inner wall face on a side opposite to the second inner wall face, and
the first conducting member extends from the first inner wall face to the third inner wall face.

7. The developing apparatus according to claim 1, further comprising:
a developing chamber configured to communicate with the accommodation portion via an opening portion, the developing chamber including:
a developer bearing member configured to bear the developer; and
a supply member configured to supply the developer in the accommodation portion to the developer bearing member,
wherein, when the developing apparatus is oriented for use in image formation in the image forming apparatus, the developing chamber is positioned below the accommodation portion.

8. The developing apparatus according to claim 1, wherein
in a case where the sheet is defined as a first sheet, the conveying member has a second sheet that is flexible and is connected to the shaft portion, and
in the cross-section, the first sheet and the second sheet are positioned, respectively, in one region and another region that are separated by an imaginary line passing through the rotation axis line.
